(19) United States
(12) Patent Application Publication
(10) Pub. No.: US 2010/0204818 A1
(43) Pub. Date: Aug. 12, 2010

(54) NUMERICAL CONTROL DEVICE

(75) Inventors: Yoshinori Yamada, Chiyoda-ku (JP); Mitsuo Watanabe, Chiyoda-ku (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION, Chiyoda-ku, Tokyo (JP)

(21) Appl. No.: 12/373,707

(22) PCT Filed: Jul. 18, 2006
(86) PCT No.: PCT/JP2006/314190

§ 371 Date: Jan. 13, 2009

(51) Int. Cl. G05B 19/18

(52) U.S. Cl. 700/179

(57) ABSTRACT

A numerical control device includes a storage unit that stores therein attached tool information; a creating unit that creates, in controlling a processing device by using a processing program, tool-use-information; a comparing unit that compares, before controlling the processing device by using the processing program, the tool-use-information with the attached tool information, and extracts difference in the tool and the tool holder as differential information; and a setup-instruction creating unit creates setup-instruction information for instructing a setup operation for attaching a tool to a tool holder of the processing device based on the differential information, and outputs the setup-instruction information to an external device.

### TECHNICAL FIELD

The present invention relates to a numerical control device that issues an instruction for setting-up necessary tools in execution of a processing program by using information about tools that were actually used in the past.

### BACKGROUND ART

As a control device that controls a process to be performed on a process object, there is available a numerical control device (hereinafter, “NC (Numerical Control) device”) that issues control instructions to a processing device that performs various processes on the process object with various types of tools. A conventional NC device would perform processing control by differentiating only between a tool that is necessary and a tool that is not necessary for the process corresponding to a processing program. Due to this, an operator has to attach a necessary tool, which is necessary for the process but has not been setup, or to detach an unnecessary tool from a tool holder.

In a tool management method disclosed in Patent document 1, for example, the NC device creates a tool list by searching the processing program for codes attached with “T” indicative of tool numbers. The NC device then compares the tool list with tool data that is pre-stored in a hard disk. After that, the NC device creates a necessary tool list including tools necessary for the process but that have not been set-up and an unnecessary tool list including tools unnecessary for the process, and causes a display device to display an instruction for tool setup operations. The operator sees this instruction for tool setup operation and setups the necessary tool to the tool holder through tool attachment or tool change.

Patent document 1: Japanese Patent Application Laid-open No. H6-43920 (pages 1 to 4, FIG. 4)

### DISCLOSURE OF INVENTION

### Problem to be Solved by the Invention

Although, in the above conventional technology, the NC device determines whether a certain tool is necessary for the process, the NC device does not have all the information about tools actually attached to the tool holders in previous process (for example, information about the tool holders to which the tools are attached). A typical NC lathe or the like processes the object with various tools being attached to the tool holders. Therefore, even a tool that is unnecessary for cutting is moved inside the machine tool during the process. Moreover, a necessary tool must be attached to not any tool holder but to a specific tool holder corresponding to the processing program.

Therefore, along with determining whether the necessary tool (tool to be used) is attached to the specific tool holder, it is necessary to prevent, if there is the unnecessary tool (tool not to be used) attached to the unnecessary tool holder, occurrence of interference between the unnecessary tool and another tool or the workpiece, etc. due to movement of the unnecessary tool. Assume, for example, both of the necessary tool and the unnecessary tool are attached to the tool holder that is slidable. When the necessary tool approaches the workpiece as the tool holder moves, the unnecessary tool on the tool holder also moves and may interfere with the workpiece. To avoid occurrence of such interference between the unnecessary tool and the workpiece, it is necessary to remove all the unnecessary tools or conduct a test to confirm that no interference occurs.

The present invention has been achieved to solve the above problems in the conventional technology and it is an object of the present invention to provide a numerical control device that facilitates changing of a tool by decreasing the number of man-hours for setting-up tools of the machine tool.

### Means for Solving Problem

To solve the above problems and to achieve the above objects, the present invention provides a numerical control device that analyzes a processing program and controls processing of a process object by a processing device based on a result of analysis of the processing program. The numerical control device includes an attached-tool-information storage unit that stores therein attached tool information including a tool that is currently attached to the processing device and a tool holder to which the tool is attached; a tool-information comparing unit that compares, before controlling the processing device by using the processing program, tool-use information including information about a past record of a tool that was used by the processing device in previous control of the processing device by using the processing program and a tool holder to which the tool was attached with the attached tool information stored in the attached-tool-information storage unit, and extracts difference in the tool and the tool holder as differential information; and a setup-instruction creating unit that creates, when the tool-information comparing unit extracts the differential information, setup-instruction information for instructing a setup operation for attaching a tool to a tool holder of the processing device based on the differential information, and outputs the setup-instruction information to an external device.

### EFFECT OF THE INVENTION

According to the invention, a numerical control device compares information about past records of tools and tool holders that were used by a processing device with information about tools that are currently attached to the processing program, extracts difference between them, and creates information for instructing operations for setting-up the tools to be attached based on the difference. Therefore, an operator can see this instruction for tool setup operation and easily perform tool change and tool settings. This brings an effect of the efficient tool change with less number of man-hours for the tool set operations.

### BRIEF DESCRIPTION OF DRAWINGS

FIG. 1 is a block diagram of a structure of an NC device according to a first embodiment.

FIG. 2 is a flowchart of a tool setup process.

FIG. 3 is a flowchart of a process of updating tool-use information.

FIG. 4 is a diagram depicting an exemplary processing program including the tool-use information.

FIG. 5 is a diagram depicting an exemplary attached-tool-data table.

FIG. 6 is a diagram depicting an exemplary tool-data table.

FIG. 7 is a diagram depicting an exemplary tool-setup-instruction display.

FIG. 8 is a block diagram of a structure of an NC device according to a second embodiment.

FIG. 9 is a block diagram of a structure of an NC device according to a third embodiment.

FIG. 10 is a diagram depicting exemplary structure of hash-value information.

### EXPLANATIONS OF LETTERS OR NUMERALS

2 processing-program input/output unit
3 processing-program storage unit
4 attached-tool-data storage unit
5 tool-data storage unit
6 tool-data input unit
7 attached-tool-data input unit
8 tool-information comparing unit
9 tool-setup-instruction creating unit
10 NC device
11 tool-use-information updating unit
12 tool-use-information editability setting unit
15 instruction input unit
20 tool
21 tool-information storage unit
31 tool-use-information storage unit
40 external storage device
50 display device
100 processing program
101 attached-tool-data table
102 tool-data table
103 hash-value information

### BEST MODE(S) FOR CARRYING OUT THE INVENTION

Exemplary embodiments of a numerical control device according to the present invention are described in detail below with reference to the accompanying drawings. The present invention is not limited to these exemplary embodiments.

### First Embodiment

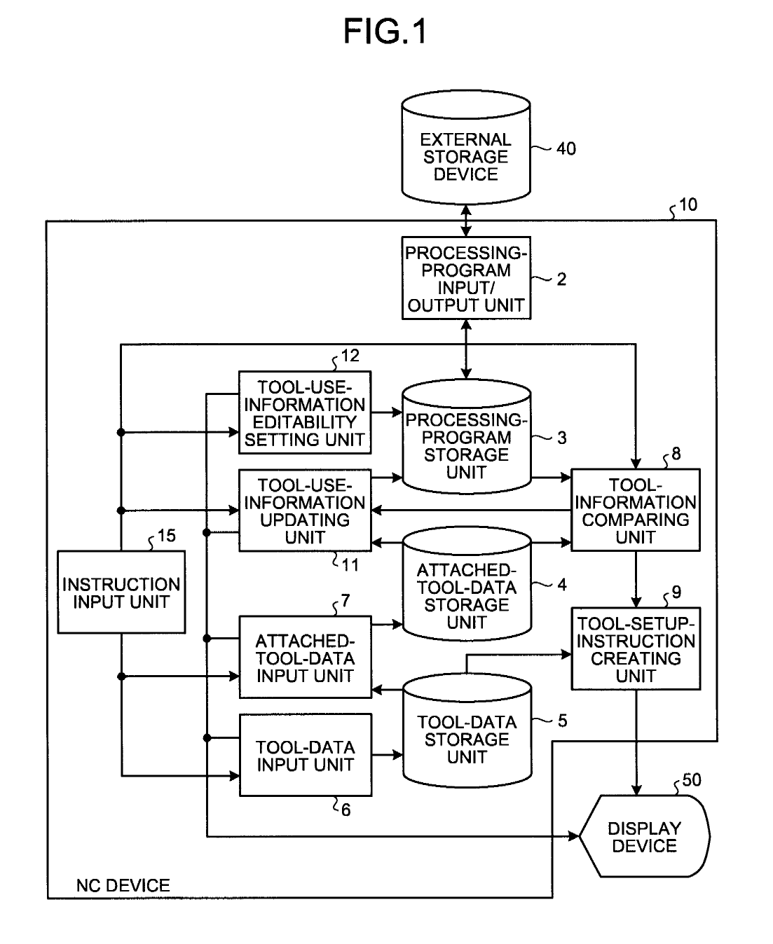

FIG. 1 is a block diagram of a structure of an NC device according to a first embodiment, and depicts the structure of relevant parts of an NC device 10. The NC device 10 is connected to an external storage device 40 and a display device 50.

The NC device 10 is a numerical control device that analyzes a processing program and controls a processing device (machine that processes a process object) based on a result of the analysis of the processing program. The NC device 10 is configured with, for example, a personal computer or the like. The NC device 10 according to the first embodiment has, as a salient feature of the present invention, a function of creating instruction information (tool-setup-instruction information) for setting-up tools or the like (hereinafter, “tool setup”).

The external storage device 40 stores therein at least one processing program that is read and analyzed by the NC device 10 to control driving of a processing device that processes a process object (workpiece) with tools.

The display device 50 is an information display device, such as a liquid crystal display monitor, that receives the tool-setup-instruction information, etc. from the NC device 10 and displays the received information.

The NC device 10 includes a processing-program input/output unit 2, a processing-program storage unit 3, an attached-tool-data storage unit (attached-tool-information storage unit) 4, a tool-data storage unit (tool-information storage unit) 5, a tool-data input unit 6, an attached-tool-data input unit 7, a tool-information comparing unit 8, a tool-setup-instruction creating unit 9, a tool-use-information updating unit (tool-use-information creating unit) 11, a tool-use-information editability setting unit (edit-lock setting unit) 12, and an instruction input unit 15.

The processing-program input/output unit 2 receives the processing program stored in the external storage device 40, and stores the processing program in the processing-program storage unit 3. Each time the later-described tool-use information (information about past records of tools that were used by the processing device and tool holders to which the tools were attached, etc.) (information stored in a form of “tool holder name=tool number” indicative of a tool that was attached to a tool holder of the machine tool or no tool being attached thereto in the previous execution of the processing program) is added to the processing program or the tool-use information added to the processing program is updated, the processing-program input/output unit 2 acquires the processing program from the processing-program storage unit 3, and outputs the processing program to the external storage device 40. The processing-program storage unit 3 stores therein the processing program received from the external storage device 40 via the processing-program input/output unit 2.

The instruction input unit 15 is used by a user (operator) of the NC device 10 to input instruction information, etc. The instruction input unit 15 can be a mouse, a keyboard, or the like. The instruction input unit 15 sends the received instruction information, etc. to any of the tool-data input unit 6, the attached-tool-data input unit 7, the tool-information comparing unit 8, the tool-use-information updating unit 11, and the tool-use-information editability setting unit 12 depending on the contents of the received information.

If receiving, for example, instruction information that specifies a processing program to be read from the external storage device 40, the instruction input unit 15 sends the instruction information to the processing-program input/output unit 2 and causes the processing-program input/output unit 2 to read the processing program. If receiving later-described tool data (information about tools each associated with tool number (e.g., type of the tool, length of the tool, and diameter of the tool), the instruction input unit 15 sends the tool data to the tool-data input unit 6. If receiving later-described attached tool data (data including all the tool holder names, each of which is associated with either a tool number of a tool currently being attached or information indicative of no tool being attached), the instruction input unit 15 sends the attached tool data to the attached-tool-data input unit 7.

The tool-data input unit 6 stores the tool data (tool information) received from the instruction input unit 15 in the tool-data storage unit 5 at a predetermined position (address). The tool-data input unit 6 outputs information (later-described tool-data table 102) stored in the tool-data storage unit 5 to the display device 50 based on the instruction information received from the instruction input unit 15.

The attached-tool-data input unit 7 stores the attached tool data (attached tool information) received from the instruction input unit 15 in the attached-tool-data storage unit 4 at a predetermined position (address). The attached-tool-data input unit 7 outputs information (later-described attached-tool-data table 101) stored in the attached-tool-data storage unit 4 to the display device 50 based on the instruction information received from the instruction input unit 15.

The attached-tool-data storage unit 4 stores therein the attached tool data received from the attached-tool-data input unit 7 as the attached-tool-data table 101. The tool-data storage unit 5 stores therein the tool data received from the tool-data input unit 6 as the tool-data table 102 (information table including tool data associated with tool number).

The tool-information comparing unit 8 compares the attached-tool-data table 101 stored in the attached-tool-data storage unit 4 with the tool-use information that is added to the processing program stored in the processing-program storage unit 3. Specifically, the tool-information comparing unit 8 compares the tool numbers of the tool holders from the attached-tool-data table 101 with the tool numbers of the tool holders from the tool-use information, and extracts non-identical tool numbers of tool holders (from the tool-use information). The tool-information comparing unit 8 sends the result of comparison between the tool numbers (tool numbers extracted from the tool-use information) to the tool-setup-instruction creating unit 9 and the tool-use-information updating unit 11.

The tool-setup-instruction creating unit 9 acquires tool information (information about tools necessary for the process such as type of the tool (tool type), length of the tool, and diameter of the tool) corresponding to the tool numbers from the tool-data storage unit 5 (tool-data table 102) by using the result of comparison between the tool numbers performed by the tool-information comparing unit 8 (tool numbers). Once the tool information (information about tools to be attached to or detached from tool holders) is acquired, the tool-setup-instruction creating unit 9 creates the tool-setup-instruction information.

The tool-use-information updating unit 11 determines, after the tool setup process is finished, whether edit-lock information is effective by referring to later-described edit-lock information (information indicative whether the tool-use information is editable) stored in the tool-use information of the processing program. The tool-use-information updating unit 11 can be configured to determine whether the edit-lock information is effective by referring to the processing program (edit-lock information) after the process performed by the processing device is finished. If the edit-lock is ineffective (“EDLK=OFF”), the tool-use-information updating unit 11 outputs information for inquiring whether the tool-use information is to be updated to the display device 50.

When the instruction input unit 15 receives information indicating that the tool-use information is to be updated, the tool-use-information updating unit 11 extracts all tool numbers of tools that are attached to the tool holders from the attached-tool-data table 101 stored in the attached-tool-data storage unit 4, and overwrites (updates) the tool-use information of the processing program stored in the processing-program storage unit 3.

The tool-use-information editability setting unit 12 activates as appropriately, during the NC device 10 being in operation, in response to a call input from the instruction input unit 15, and outputs information for inquiring whether the edit-lock information is to be changed to the display device 50. When the instruction input unit 15 receives the instruction information for switching the edit lock in the processing program to effective from ineffective or vice versa, the tool-use-information editability setting unit 12 updates the edit-lock information included in the tool-use information stored in the processing program.

Processes performed by the NC device 10 are then described below. A tool setup process performed by the NC device 10 is described first, and an updating process in which the NC device 10 updates the tool-use information is described after that.

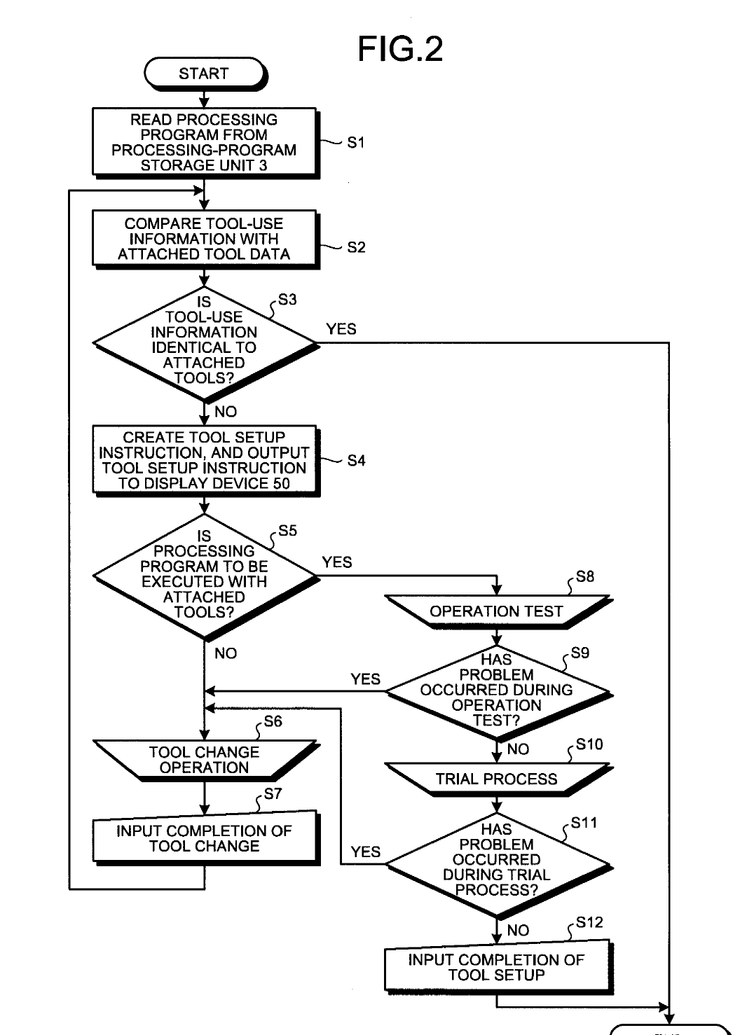

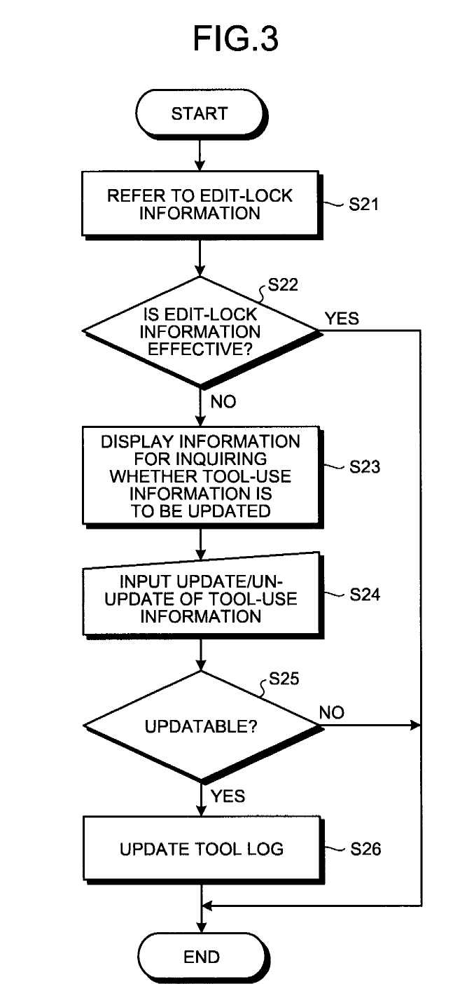

FIG. 2 is a flowchart of the tool setup process performed by the NC device; FIG. 3 is a flowchart of the updating process in which the NC device updates the tool-use information. The operator inputs the tool data (the tool information associated with the tool number) and the attached tool data (the tool holder name associated with the tool number) by using the instruction input unit 15. When doing so, the operator checks the tools that are attached to the tool holders and inputs the attached tool data. In other words, the operator checks for the tool numbers of the tools that have been currently attached to the tool holders, and inputs the tool holders (tool holder names) and the tool numbers in the associated manner. Moreover, the operator checks the tool data about tools attached to the tool holders and the tool data table, and inputs the tool data about a tool attached to the tool holder but absent from the tool data table. More particularly, the operator inputs the tool number, the type of the tool, the length of the tool, etc. of the tool that is absent from the tool data table as the tool data.

The instruction input unit 15 sends the tool data and the attached tool data to both the tool-data input unit 6 and the attached-tool-data input unit 7. The tool-data input unit 6 stores the tool data in the tool-data storage unit 5; and the attached-tool-data input unit 7 stores the attached tool data in the attached-tool-data storage unit 4.

To start the process of the process object by the processing device, the operator specifies the processing program necessary for the tool setup (processing program necessary for processing the process object) by inputting the instruction information via the instruction input unit 15 to cause the NC device 10 to read the processing program from the external storage device 40.

The processing-program input/output unit 2 of the NC device 10 reads the processing program specified by the operator (i.e., the processing program that satisfies the request from the operator) from among the processing programs stored in the external storage device 40, and stores the processing program in the processing-program storage unit 3.

After that, the NC device 10 causes the processing device to process the process object. More particularly, the NC device 10 sequentially reads the processing program from the processing-program storage unit 3 by using a processing-program reading unit (not shown) (Step S1), and inputs the read processing program to a processing-program analyzing unit (not shown). For example, the NC device 10 sets the processing program requested from the operator via the instruction input unit 15, and starts the reading process and the analyzing process of the processing program in response to pressing of an automatic activation button on an operation panel by the operator.

The processing program that is input to the processing-program analyzing unit includes various commands such as G commands and F commands for specifying a tool path or a tool conveying speed, M commands for specifying machine operations, S commands for specifying a rotation rate of a major shaft, etc., and T commands for specifying a tool with which the object is processed.

The processing-program analyzing unit analyzes commands that require analysis of the processing program (e.g., calculates coordinate values) to obtain, for example, the tool path and the tool motion, and creates motion control data for controlling motions of control shafts. The NC device 10 drives a driving unit (not shown) of the processing device such as a motor by inputting the motion control data created by the processing-program analyzing unit to the motor, and thereby causes the processing device to process the process object in such a manner that the tools and the workpiece moves relatively. The processing-program analyzing unit sends those commands that require no analysis to a not-shown function processing unit. Such commands are used for a control mode of the NC device 10 and for control of mechanical operations.

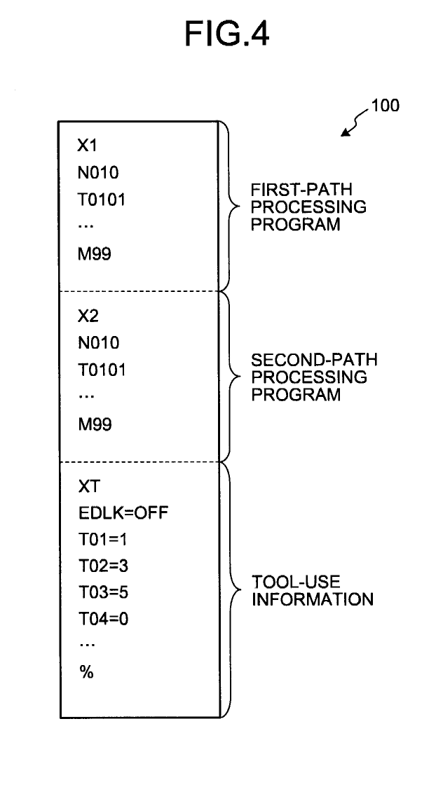

FIG. 4 is a diagram depicting an exemplary processing program including the tool-use information. The processing program is added at its tail with data about the arrangement of tools necessary for the mechanical process as the tool-use information. The tool-use information is information about all the tool holders of the processing device that performs the mechanical process, each associated with the corresponding tool number for identifying the tool attached thereto or information indicative that no tool was attached.

A processing program 100 shown in FIG. 4 is an example of the processing program with multi-paths for a machine tool. The processing program 100 includes a first-path program that begins with “X1” (first-path processing program), a second-path program that begins with “X2” (second-path processing program), and the tool-use information that begins with “XT”.

The processing program 100 is described in such a manner that if the processing program 100 is executed sequentially from its head, the first-path processing program and the second-path processing program cannot cooperate concurrently. Therefore, all the processing program 100 in the processing-program storage unit 3 is read from its head to a symbol indicated by “%” indicative of end of recodes. After that, the NC device 10 concurrently reads the processing program that begins with “X1” and the processing program that begins with “X2” of the processing program 100 from the processing-program storage unit 3 and executes the processing program 100 from their heads. Thus, the first-path processing program and the second-path processing program cooperate, which makes it possible to process the object into a desired product.

The tool-use information that begins with “XT” is stored in the processing-program storage unit 3 together with the first-path processing program and the second-path processing program. The tool-use information is stored in such a manner that each of tool holders of the machine tool is associated with information about a corresponding tool attached thereto or information indicative that no holder was attached thereto in the previous execution of the processing program 100 in a form of “tool holder name=tool number”.

For example, in the processing program 100 shown in FIG. 4, a description “T01=0” means that a tool assigned with a tool number “1” stored in the tool-data storage unit 5 was attached to a tool holder named “T01”.

It is assumed in the first embodiment that a tool number “0” indicates that no tool is attached. That is, “T04=0” in the processing program 100 shown in FIG. 4 means that no tool was attached to a tool holder “T04”.

The tool-use information that begins with “XT” includes the edit-lock information indicative whether the tool-use information is editable (or uneditable) as “EDLK=ON (or OFF)”. If the edit-lock information is “EDLK=ON”, it means that the tool-use information is uneditable. If the edit-lock information is “EDLK=OFF”, it means that the tool-use information is editable. The contents of the tool data is referred to or updated as appropriately in the first embodiment.

When the processing-program reading unit reads the tool command (T command) of the processing program from the processing-program storage unit 3, the processing-program analyzing unit identifies the tool number of the tool that is attached to the tool holder specified by using the T command by referring to the attached tool data stored in the attached-tool-data storage unit 4. The processing-program analyzing unit acquires tool information necessary for analyzing the processing program (type of the tool, length of the tool, diameter of the tool, etc.) from the tool-data storage unit 5 by the tool number as a key.

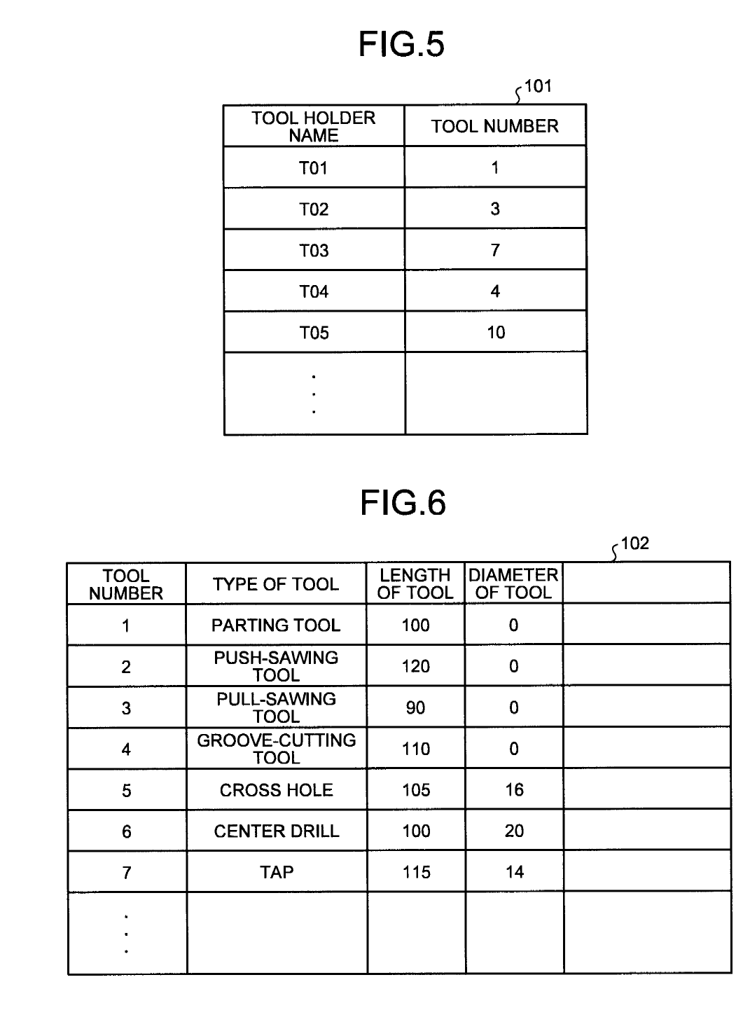

FIG. 5 is a diagram depicting an exemplary attached-tool-data table; and FIG. 6 is a diagram depicting an exemplary tool-data table. As shown in FIG. 5, the attached-tool-data table 101 is an information table including all the tool holders (holder names) of the machine tool, each associated with the corresponding tool number of the tool currently attached thereto or information indicative that no tool is attached.

As shown in FIG. 6, the tool-data table 102 includes tool information necessary for the process as records such as type of the tool (tool type), length of the tool, and diameter of the tool. The tool-data table 102 is an information table including tool information associated with tool number. In the tool-data table 102, the number of record is treated as the tool number and works as a unique key for identifying the tool.

A process of attaching an unregistered tool, i.e., tool data that has been not stored in the tool-data storage unit 5, to the tool holder is described below. The tool data such as type of the tool, length of the tool, and diameter of the tool is input by the operator via the instruction input unit 15. The tool-data input unit 6 adds the tool information such as type of the tool, length of the tool, and diameter of the tool to the tool-data table 102 as a record with an arbitrary number in the tool-data storage unit 5. After that, information for specifying the tool holder to/from which the tool is to be attached/detached is input by the operator via the instruction input unit 15. The attached-tool-data input unit 7 extracts, by referring to the tool-data storage unit 5, the tool number corresponding to the tool information, and stores the tool number in the attached-tool-data storage unit 4 (attached-tool-data table 101) in such a manner that the tool number is associated with the specified tool holder name.

The NC device 10 starts the tool setup process after those pieces of data are stored in corresponding one of the processing-program storage unit 3, the attached-tool-data storage unit 4, and the tool-data storage unit 5. The tool-information comparing unit 8 compares the attached-tool-data table 101 stored in the attached-tool-data storage unit 4 with the tool-use information that is written to the processing program stored in the processing-program storage unit 3. More particularly, the tool-information comparing unit 8 compares the tool numbers of the tools attached to the tool holders from the attached-tool-data table 101 with the tool numbers of the tool holders from the tool-use information (Step S2).

If the result of the comparison between the tool numbers by the tool-information comparing unit 8 is concordant for every tool holder (YES at Step S3), the tool setup is not required because the tool satisfying conditions for performing the process has already been attached in every tool holder. Thus, the process control terminates the tool setup process.

On the other hand, if the result of the comparison between the tool numbers by the tool-information comparing unit 8 is not concordant for one or more tool holders (NO at Step S3), the NC device 10 performs the tool-setup-instruction process because it is required to attach one or more tools satisfying conditions for performing the process to corresponding tool holders.

The tool-information comparing unit 8 of the NC device 10 extracts all the tool holders to/from which the tools are to be attached/detached (tool holders having non-identical tool numbers as the results of comparison between the tool numbers) from the tool-use information to match the attached-tool-data table 101 stored in the attached-tool-data storage unit 4 to the tool-use information. The tool-information comparing unit 8 also extracts the tool numbers corresponding to the extracted tool holders from the tool-use information. The tool-information comparing unit 8 sends the extracted tool numbers (differential information) to the tool-setup-instruction creating unit 9.

The tool-setup-instruction creating unit 9 acquires the tool information corresponding to the received tool numbers from the tool-data table 102 stored in the tool-data storage unit 5 by the extracted tool numbers as keys. Upon acquiring the tool information about tools to be attached/detached, the tool-setup-instruction creating unit 9 creates the tool-setup-instruction information from the acquired information. The tool-setup-instruction creating unit 9 outputs the created tool-setup-instruction information to the display device 50 (Step S4). The display device 50 gives a notice about the tool setup instruction to the operator by making a display based on the tool-setup-instruction information.

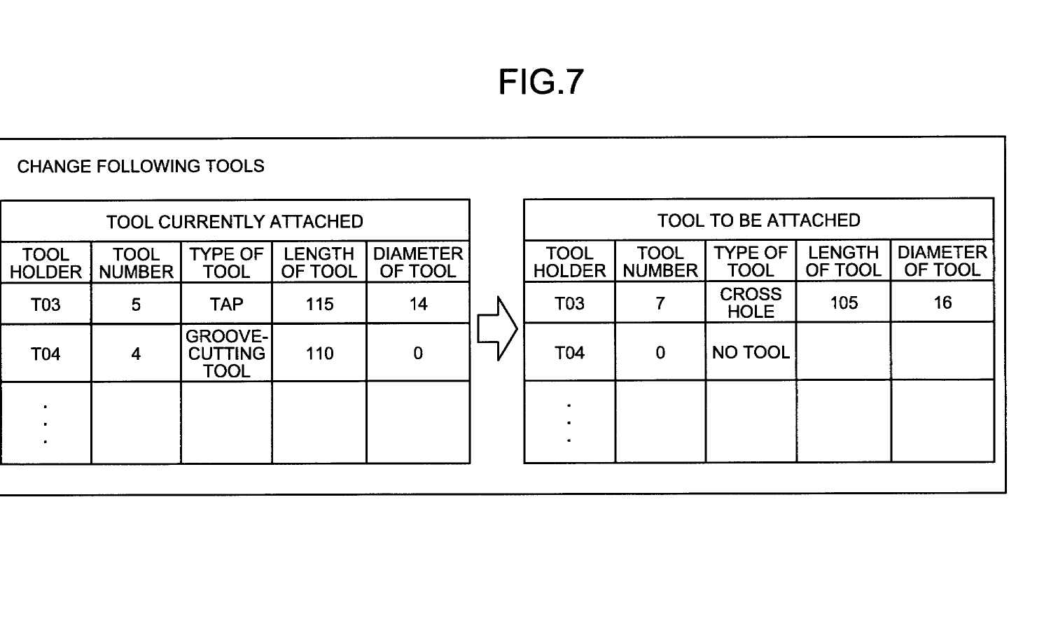

FIG. 7 is a diagram depicting an exemplary tool-setup-instruction display. As shown in FIG. 7, the tool setup instruction is information every tool holder having the non-identical tool numbers between the tool-use information and the attached-tool-data table 101, each associated with tool holder name, tool number extracted from the tool-use information, and tool information corresponding to the tool number.

In displaying the tool setup instruction, both the tool information about the tool currently attached and the tool information about the tool to be attached are displayed, associated to the corresponding holder name. For example, the tool currently attached to a tool holder name “T03” has the tool number of “5”, the type of the tool of “tap”, the length of the tool of “115”, and the diameter of the tool of “14”. The tool to be attached to the tool holder name “T03” has the tool number of “7”, the type of the tool of “cross hole”, the length of the tool of “105”, and the diameter of the tool of “16”.

When the display device 50 notifies the tool setup instruction, the operator checks the tool setup instruction displayed on the display device 50, and determines, by referring to the tool setup instruction, whether the tool attached to the tool holder is to be changed (Step S5). In other words, the operator determines either to execute the processing program with the current arrangement of the tools attached to the tool holders, or to execute the processing program with another arrangement by changing the tools attached to the tool holders. The operator inputs a result of determination via the instruction input unit 15 of the NC device 10.

If an instruction of changing the tools attached to the tool holders is received, it is determined that the tool change is to be performed. If no instruction of changing the tools attached to the tool holders is received, it is determined that no tool change is to be performed. If the operator determines, by referring to the tool setup instruction, that the change of the tools attached to the tool holders is to be performed (NO at Step S5), the operator performs the tool change operation including removal of the tool, attachment of the tool, and update of the attached-tool-data table 101 (Step S6).

After that, when information indicative of completion of the tool change is input by the operator via the instruction input unit 15 (Step S7), the tool-information comparing unit 8 returns to the process at Step S2. The NC device 10 repeats the processes from Step S2 to Step S7 until the result of comparison between the tool numbers by the tool-information comparing unit 8 (result of comparing the tool number of the tool attached to the tool holder from the attached-tool-data table 101 with the tool number of the tool holder from the tool-use information) is concordant for every tool holder at Step S3, or until it is determined at Step S5 that the processing program is to be executed with the current arrangement of the tools attached to the tool holders.

In the above description, the tool-setup-instruction creating unit 9 creates the tool-setup-instruction information, and outputs the tool-setup-instruction information to the display device 50, thereby notifying the tool setup instruction of the operator. Alternatively, the tool-setup-instruction creating unit 9 can be configured to create the tool-setup-instruction information as an instruction for controlling an automatic tool changer (external device that automatically changes tools) or a robot. In this case, the tool-setup-instruction creating unit 9 outputs the created tool-setup-instruction information to the automatic tool changer or the robot at Step S4. The automatic tool changer or the robot performs the tool change operation (removal of the tool, attachment of the tool, and update of the attached-tool-data table 101) based on the tool-setup-instruction information (Step S6). After that, when information indicative of completion of the tool change is input by the automatic tool changer or the robot via the instruction input unit 15 (Step S7), the tool-information comparing unit 8 returns to the process at Step S2.

If it is determined at Step S5 that the processing program is to be executed with the current arrangement of the tools attached to the tool holders (YES at Step S5), the operator executes the processing program with the current tool arrange, and conducts an operation test of the processing device (machine) (Step S8).

The operator checks whether a problem, such as interference, has occurred when the processing program is executed with the current tool arrangement (Step S9). The operator inputs a result of check via the instruction input unit 15 of the NC device 10. If a problem has occurred during the operation test (YES at Step S9), the tool change operation is performed for changing the trouble tool (Step S6). When information indicative of completion of the tool change is input by the operator via the instruction input unit 15 (Step S7), the process control returns to Step S2 and the tool-information comparing unit 8 repeats the processes from Step S2 to S7.

If no problem has occurred during the operation test (NO at Step S9), the NC device 10 performs a trial process to confirm that the NC device 10 can perform the process properly in an actual case (Step S10). The operator then checks whether a problem has occurred during the trial process.

If having checked that no problem has occurred during the trial process (NO at Step S11), the operator inputs information indicative of completion of the tool setup via the instruction input unit 15 (Step S12) and the process control terminates the setup process.

On the other hand, if a problem has occurred during the trial process (YES at Step S11), the tool change operation is performed for changing the trouble tool (Step S6). When the information indicative of completion of the tool change is input by the operator via the instruction input unit 15 (Step S7), the process control returns to Step S2 and the tool-information comparing unit 8 repeats the processes from Step S2 to S7.

It is allowable to perform at Step S6 another tool change different from the tool change following the tool setup instruction. In other words, the tool arrangement with which the process is actually performed can be different from the tool arrangement indicated by the tool-use information. If, for example, a tool indicated by the tool-use information is disabled due to some reasons or there is an alternative tool that is expected to increase the processing accuracy, it is allowable to attach the alternative tool. Moreover, if there is a tool that has already been attached to the tool holder but unnecessary for the process, it is allowable to perform the process with the tool being attached, thus saving the tool change.

The processes of creating and updating the tool-use information are described with reference to the flowchart shown in FIG. 3. Upon receiving information that indicates completion of the tool setup at the end of the above-described tool setup process, the tool-use-information updating unit 11 refers to the edit-lock information stored in the tool-use information of the processing program (Step S21). The tool-use-information updating unit 11 determines whether the edit-lock information is effective (Step S22).

If the edit-lock information is effective (“EDLK=ON”) (YES at Step S22), the tool-use-information updating unit 11 does not update the tool-use information. On the other hand, if the edit-lock information is ineffective (“EDLK=OFF”) (NO at Step S22), the tool-use-information updating unit 11 outputs information for inquiring whether the tool-use information is to be updated to the display device 50. The display device 50 displays thereon information for inquiring whether the tool-use information is to be updated (e.g., message for inquiring whether the tool-use information is to be updated) (Step S23). Thus, the NC device 10 leads the operator to make a determination of update/un-update of the tool-use information, and the operator inputs information indicative of update/un-update of the tool-use information via the instruction input unit 15 (Step S24).

If receiving information indicative of un-update via the instruction input unit 15 (No at Step S25), the tool-use-information updating unit 11 does not update the tool-use information. On the other hand, if receiving information indicative of update via the instruction input unit 15 (YES at Step S25), the tool-use-information updating unit 11 extracts all the tool numbers of tools attached to the tool holders from the attached-tool-data table 101 stored in the attached-tool-data storage unit 4. The tool-use-information updating unit 11 overwrites information about all the tool holders as the tool-use information in such a manner that each of the tool holders is associated with the corresponding tool number (Step S26).

The tool-use-information editability setting unit 12 activates as appropriately, during the NC device 10 being in operation, in response to a call from the instruction input unit 15, and outputs information for inquiring whether the edit-lock information is to be changed to the display device 50.

When the operator inputs information for specifying a target processing program stored in the processing-program storage unit 3 and information for setting the edit lock of the target processing program to effective/ineffective via the instruction input unit 15, the tool-use-information editability setting unit 12 updates the edit-lock information added to the tool-use information stored in the specified processing program.

More particularly, upon receiving information for setting the edit lock to ineffective via the instruction input unit 15, the tool-use-information editability setting unit 12 sets the edit-lock information of the tool-use information to “EDLK=OFF”. On the other hand, upon receiving information for setting the edit lock to effective via the instruction input unit 15, the tool-use-information editability setting unit 12 sets the edit-lock information of the tool-use information to “EDLK=ON”.

If, at Step S3 of FIG. 2, the result of comparison between the tool numbers by the tool-information comparing unit 8 is concordant for every tool holder (YES at Step S3), the tool-use-information updating unit 11 does not receive information indicative of completion of the tool setup at the end of the tool setup process. Therefore, the tool-use-information updating unit 11 does not update the tool-use information. The tool-use-information updating unit 11 can be configured to determine that the tool data is not to be updated based on the result of comparison between the tool numbers received from the tool-information comparing unit 8 (no tool number is identical).

According to the first embodiment, the tool setup instruction is displayed in the process of executing the processing program to implement the tool arrangement with which the processing program ran properly in the past. This makes it possible for the operator to easily change tools by following the tool setup instruction, i.e., to easily select the tools necessary for the process of the processing program and attach the necessary tools to the corresponding tool holders.

Moreover, if the tool unnecessary for the process is attached to the tool holder, the tool setup instruction is displayed only when the unnecessary tool is different from the one attached in the previous execution of the processing program. This saves a process of detaching all the unnecessary tools or a process of confirming that no interference by the unnecessary tool occurs. In this manner, the NC device recommends an efficient tool change with a less number of man-hours for the tool set operations in the tool machine, and thereby the process starts immediately.

Furthermore, the tool-use information is created, after the trial process is performed with the tools actually attached to the tool holders, in such a manner that the attached tool data in the current arrangement (tool arrangement) is automatically stored in the processing program as the tool-use information, which saves manual storing of the tool-use information.

Moreover, as for the update of the tool-use information, even if an alternative tool or the like is used instead of the tool used in the previous execution of the processing program, the attached-tool-data table 101 is created when the processing program is executed and thereby the tool-use information is automatically updated. This saves the man-hour for manual updating the tool-use information. In this manner, the number of man-hours for the tool setup operations, the number of man-hours for creating the tool-use information that is used for the tool setup instructions, and the number of man-hours for updating the tool-use information decreases remarkably, which prevents occurrence of errors related to these operations.

Furthermore, as for the management of the tool-use information, the tool-use information and the processing program are integrally managed by storing the processing program and the corresponding tool-use information during the processing program. If, for example, the processing program is managed with the processing program stored in the external storage device 40 and if the processing program and the tool-use information are separately managed, there is a possibility of losing the association between the processing program and the tool-use information. However, because the tool-use information and the processing program are integrally managed in the first embodiment, the association between the processing program and the tool-use information maintains. Therefore, no error such as mismatch between the processing program and the tool-use information occurs. Moreover, because no special device other than the NC device 10 is required, it is possible to display the tool setup instruction with the simple structure and with a low cost.

### Second Embodiment

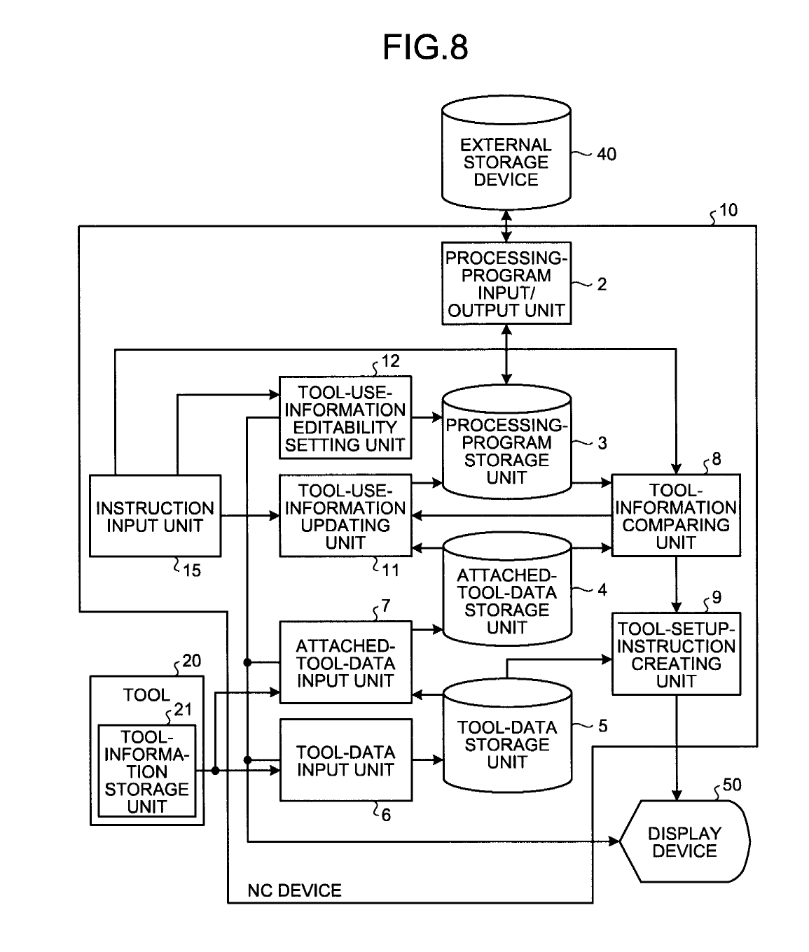

A second embodiment of the present invention is described with reference to FIG. 8. In the second embodiment, the NC device 10 acquires information about tools from an external device (later-described tool-information storage unit 21), and stores the information in the tool-data table 102 and the attached-tool-data table 101.

FIG. 8 is a block diagram of a structure of an NC device according to the second embodiment. Components shown in FIG. 8 corresponding to those of the NC device 10 according to the first embodiment shown in FIG. 1 are denoted with the same reference numerals, and the same description is not repeated.

In the NC device 10 according to the second embodiment, the attached-tool-data input unit 7 and the tool-data input unit 6 are connected to the tool-information storage unit (external device) 21 incorporated in a tool 20. The tool-information storage unit 21 is a storage unit such as a microchip, and stores therein tool data similar to the information stored in the tool-data storage unit 5.

The attached-tool-data input unit 7 reads information about the tool 20 from the tool-information storage unit 21, and compares the obtained tool data with the tool data stored in the tool-data storage unit 5. If a matching tool (record) is found in the comparison of the tool data read from the tool-information storage unit 21 with the tool data stored in the tool-data storage unit 5, the tool data is not stored in the tool-data table 102.

On the other hand, if no matching tool (record) is found, i.e., the tool data read from the tool-information storage unit 21 is not stored in the tool-data storage unit 5 (tool-data table 102), the tool-data input unit 6 adds the tool data read from the tool-information storage unit 21 to the tool-data table 102 as new tool information (record). The other structure and operations of the NC device 10 are similar to those in the first embodiment, and the same description is not repeated.

According to the second embodiment, the NC device 10 acquires information about tools from the tool-information storage unit 21, and stores the information in the tool-data table 102 and the attached-tool-data table 101, which saves a process of manual input of information to the attached-tool-data table 101 and the tool-data table 102. This prevents occurrence of errors related to storing information in the attached-tool-data table 101 and the tool-data table 102.

### Third Embodiment

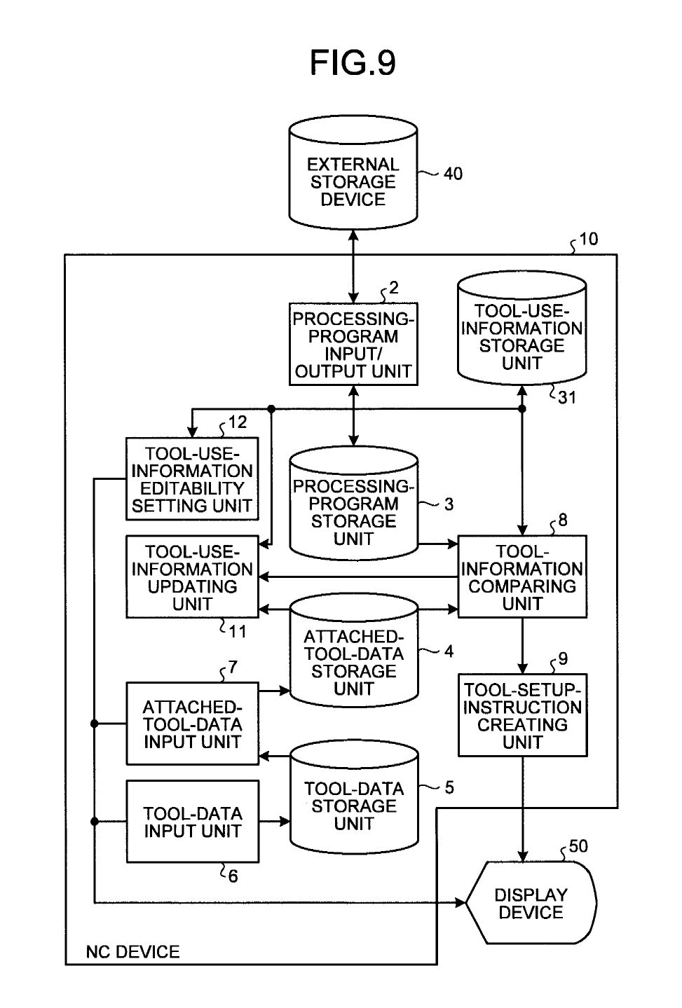

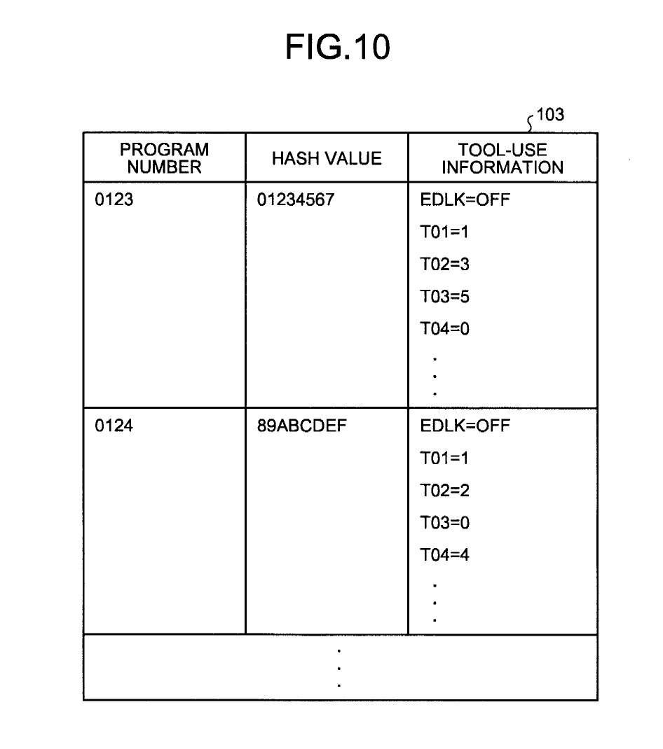

A third embodiment of the present invention is described with reference to FIG. 9 and FIG. 10. In the third embodiment, a hash value is used as a search key for searching a database that stores therein the tool-use information. A record including the necessary edit-lock information and the tool holders associated with the tool numbers are acquired from the processing program to be executed by searching for the hash value.

FIG. 9 is a block diagram of a structure of an NC device according to the third embodiment. Components shown in FIG. 9 corresponding to those of the NC device 10 according to the first embodiment shown in FIG. 1 are denoted with the same reference numerals, and the same description is not repeated.

The NC device 10 according to the third embodiment includes a tool-use-information storage unit 31. The tool-use-information storage unit 31 is a database that stores therein records (later-described hash-value information 103) including the edit-lock information and the tool holders associated with the tool numbers (tool-use information). The tool-use-information storage unit 31 is connected to the tool-information comparing unit 8, the tool-use-information updating unit 11, and the tool-use-information editability setting unit 12.

The tool-information comparing unit 8 is connected to the processing-program storage unit 3, the attached-tool-data storage unit 4, the tool-use-information updating unit 11, the tool-use-information editability setting unit 12, the tool-setup-instruction creating unit 9, and the tool-use-information storage unit 31. The instruction input unit 15 incorporated in the NC device 10 is not shown in FIG. 9.

The tool-information comparing unit 8 of the NC device 10 calculates the hash value of the processing program that is stored, after read by the processing-program input/output unit 2 from the external storage device 40, in the processing-program storage unit 3. The tool-information comparing unit 8 searches records stored in the tool-use-information storage unit 31 (hash-value information 103) by using a processing-program number (e.g., “O123”) and the hash value as keys. If the search succeeds, the tool-information comparing unit 8 extracts the tool-use information corresponding to the processing program that is read from the external storage device 40 from the hash-value information 103.

The structure of the hash-value information 103 is described below. FIG. 10 is a diagram depicting exemplary structure of the hash-value information. The hash-value information 103 is a database including program number, hash value, and tool-use information, those associated with each other. The hash-value information 103 is information similar to the tool-use information added to the processing program in the first embodiment, and includes the edit-lock information and the tool holders associated with the tool number as records (tool-use information). For example, the tool-use information with the program number “O123” and the hash value “01234567” includes “EDLK=OFF” as the edit-lock information and “T01=1”, etc. as the tool holder associated with the tool number.

Upon extracting from the hash-value information 103 the tool-use information corresponding to the processing program that has been read from the external storage device 40, the tool-information comparing unit 8 compares the tool numbers of tools attached to the tool holders extracted from the tool-use information with the tool number of the tool holder from the attached-tool-data table 101. This tool-number comparing process by the tool-information comparing unit 8 is equivalent to the process at Step S2 in the first embodiment (FIG. 2).

On the other hand, if the search of the hash-value information 103 for the tool-use information fails (no tool-use information corresponding to the processing program is stored), the tool-information comparing unit 8 stores the processing-program number, the hash value, and the edit-lock information in the tool-use-information storage unit 31 (hash-value information 103) as a new record. The tool-information comparing unit 8 stores “EDLK=OFF” as the edit-lock information if the tool-use information is editable, or “EDLK=ON” as the edit-lock information if the tool-use information is uneditable.

The hash value is described below. The hash value is short data mathematically calculated from target data by using a special calculation method called hash function. The use of the hash value is widely known as the method for increasing search speed. Examples of the calculation methods using the hash value are disclosed in documents in the field of mathematics and on the Internet, etc. The hash value is used as a search key for searching the tool-use-information storage unit 31 to search for a record that matches with the hash value, which results in acquiring a correct record including the necessary edit-lock information and the tool holders associated with the tool numbers from the processing program to be executed. Even if there is stored a plurality of records corresponding to the processing program with the same program number, the correct record including the necessary edit-lock information and the tool holders associated with the tool numbers is acquired from the processing program to be executed.

Upon receiving information indicative of completion of tool setup at the end of the tool setup process shown in FIG. 2 in the first embodiment (Step S12), the tool-use-information updating unit 11 calculates the hash value of the executed processing program. The tool-use-information updating unit 11 updates the tool-use-information storage unit 31 (hash-value information 103) by referring to the tool-use information corresponding to the executed processing program, which is the processing program stored in the tool-use-information storage unit 31. The flow of the updating process is similar to that in the first embodiment, and the same description is not repeated.

The tool-use-information editability setting unit 12 calculates the hash value of the processing program specified by the instruction input unit 15, and extracts the specified processing program from among the processing programs stored in the tool-use-information storage unit 31. The tool-use-information editability setting unit 12 then updates the edit-lock information in the extracted tool-use information in the same manner as in the first embodiment.

According to the third embodiment, the number of man-hours for the tool setup operations, the number of man-hours for creating the tool-use information that is used for the tool setup instructions, and the number of man-hours for updating the tool-use information decreases remarkably, which prevents occurrence of errors related to these operations.

Moreover, because no special device other than the NC device 10 is required, it is possible to display the tool setup instruction with the simple structure and with a low cost. Furthermore, because the format remains unchanged in the same form as in the conventional processing program in the third embodiment, the same effects are implemented with the existing processing program without a format change. Therefore, even machine tools other than the NC device 10 can use the processing program as it is used in the third embodiment.

### INDUSTRIAL APPLICABILITY

As set forth hereinabove, a numerical control device according to the present invention is suitable for issuing an instruction for setting-up tools with which a processing device processes a process object.

1.-9. (canceled)

10. A numerical control device that analyzes a processing program and controls processing of a process object by a processing device based on a result of analysis of the processing program, the numerical control device comprising:
an attached-tool-information storage unit that stores therein attached tool information including a tool that is currently attached to the processing device and a tool holder to which the tool is attached;
a tool-use-information creating unit that creates, in controlling the processing device by using the processing program, tool-use-information including information about a past record of a tool that was used by the processing device and a tool holder to which the tool was attached;
a tool-information comparing unit that compares, before controlling the processing device by using the processing program, the tool-use-information created by the tool-use-information creating unit with the attached tool information stored in the attached-tool-information storage unit, and extracts difference in the tool and the tool holder as differential information; and
a setup-instruction creating unit that creates, when the tool-information comparing unit extracts the differential information, setup-instruction information for instructing a setup operation for attaching a tool to a tool holder of the processing device based on the differential information, and outputs the setup-instruction information to an external device.

11. The numerical control device according to claim 10, further comprising a tool-information storage unit that stores therein tool information about the tool received from the external device, wherein
the setup-instruction creating unit creates the setup-instruction information by using the tool information stored in the tool-information storage unit.

12. The numerical control device according to claim 10, further comprising a tool-use-information storage unit that stores therein the tool-use information corresponding to the processing program in such a manner that the tool-use information is associated with a hash value calculated based on the processing program, wherein
the tool-information comparing unit calculates the hash value based on the processing program that is to be used for control of the processing device, extracts the tool-use information from the tool-use-information storage unit by using calculated hash value, and extracts the differential information by comparing extracted tool information with the attached tool information stored in the attached-tool-information storage unit.

13. A numerical control device that analyzes a processing program and controls processing of a process object by a processing device based on a result of analysis of the processing program, the numerical control device comprising:
an attached-tool-information storage unit that stores therein attached tool information including a tool that is currently attached to the processing device and a tool holder to which the tool is attached;
a tool-use-information creating unit that creates, in controlling the processing device by using the processing program, tool-use information including information about a tool that was used by the processing device and a tool holder to which the tool was attached;
a tool-information comparing unit that compares, before controlling the processing device by using the processing program, the tool-use information created by the tool-use-information creating unit with the attached tool information stored in the attached-tool-information storage unit, and extracts difference in the tool and the tool holder as differential information; and
a setup-instruction creating unit that creates, when the tool-information comparing unit extracts the differential information, setup-instruction information for instructing a setup operation for attaching a tool to a tool holder of the processing device based on the differential information, and outputs the setup-instruction information to an external device, wherein
the processing program includes a symbol that is used for discriminating a program area in which the tool-use information is stored from a storage area in which the tool-use information is stored, and
the tool-use-information creating unit updates, after the setup operation, the tool-use information stored in the processing program to tool-use information for controlling the processing device based on the attached tool information, and stores processing program added with updated tool-use information in the external storage device.

14. The numerical control device according to claim 13, further comprising an edit-lock setting unit that sets or updates edit-lock information based on instruction information that is received from outside, the edit-lock information being included in the tool-use information stored in the processing program, and indicative of whether the tool-use-information creating unit is allowed to update the tool-use information, wherein
if the tool-use-information creating unit determines that the tool-use information is updatable based on the edit-lock information, the tool-use-information creating unit updates the tool-use information stored in the processing program to the tool-use information for controlling the processing device based on the attached tool information, and if the tool-use-information creating unit determines that the tool-use information is not updatable based on the edit-lock information, the tool-use-information creating unit protects the tool-use information so that the tool-use information described in the processing program cannot be updated after the setup operation.
